(19) United States
(12) Patent Application Publication
(10) Pub. No.: US 2023/0247018 A1
(43) Pub. Date: Aug. 3, 2023

(54) SYSTEM AND METHOD FOR SECURE ELECTRONIC DOCUMENT EXCHANGE AND EXECUTION OF CONTRACTS VIA A SECURE ELECTRONIC PLATFORM WITH BIOMETRIC ACCESS VERIFICATION

(71) Applicant: Nidhi Dutt, Kensington, CA (US)

(72) Inventor: Nidhi Dutt, Kensington, CA (US)

(21) Appl. No.: 18/103,392

(22) Filed: Jan. 30, 2023

Related U.S. Application Data
(60) Provisional application No. 63/305,214, filed on Jan. 31, 2022.

(51) Int. Cl. H04L 9/40

(52) U.S. Cl. CPC H04L 63/0838; H04L 63/0861; H04L 63/0428

(57) ABSTRACT

The present invention is a system and method for secure electronic document exchange and execution of contracts and digital consent via a secure electronic platform with biometric access verification. A user receives a one-time password (OTP) via a short message service (SMS) on a mobile phone. Within a secure system, this unique temporary code is fused with the user's biometric data to create a secure tokenized digital identity which the user can utilize to electronically sign a document or provide digital consent in a mobile-first environment. Any document signed, or consent process completed, by the individual is stored within the present invention's secure servers. The user accesses the platform's secure web-based system to view, download and share via instant message, email or any other digital communication method all documents and consent materials they are a party to anywhere, anytime, in perpetuity. The present invention provides improved accessibility to digitally sign documents and provide consent.

### CROSS REFERENCE TO RELATED APPLICATIONS

This application claims the benefit of U.S. Provisional Patent Application Ser. No. 63/305,214 filed on Jan. 31, 2022, the contents of which are incorporated herein by reference.

### BACKGROUND OF THE INVENTION

The present invention is directed to the accessibility of electronic documents and digital consent.

Electronic signatures, also known as “e-signing”, is an acceptable and commonplace form of digital contract execution. However, the number of people worldwide who can access, and benefit, from this digital process are limited by current technology and business practices. Based on the existing global e-signing market, it is fair to say that at least half of the world's population does not have the access and agency to complete paperwork digitally, mostly because their identities are not expressed by, or connected to, an active email address, among other digital identifiers.

Platforms such as DocuSign, Dropbox Sign, and Adobe Sign, to name a few, do not adequately enable the completion of vital paperwork or provision of electronic consent across a whole host of industries—from field research and humanitarian aid, to healthcare and government. Not only do these platforms strictly require email addresses, but their success is also based on predefined and preplanned digital paperwork transactions, as well as the literacy and technological capability of users. Predetermined paperwork where everything is pre-planned, including which parties will participate and how and where they will e-sign, is fast becoming a thing of the past. With the world operating in the here and now and at break-neck speed, agile and on-the-go mobile-first technology is crucial to maximizing digital paperwork and consent process outcomes for more people across diverse technological landscapes, globally.

The present invention's ecosystem provides more than just a system for signatories. It also streamlines the document generation and creation process by utilizing a database of previous agreements, provides identity verification, stores documents offline in a digital repository, and provides users with document oversight, irrespective of their platform/product subscription status.

Due to the recent global shifts that resulted from the COVID-19 pandemic, the uses of electronic documents, digital signatures and virtual, digital consent have exponentially increased. With that, the use of platforms like DocuSign, Dropbox Sign, and Adobe Sign, among others, has become much more necessary—not only as enterprise or “productivity” tools but as necessary communication tools in everyday life. However, existing platforms do not appeal to global consumer audiences and as such, do not have mass adoption or use, in large part because they are tied to email as a primary and/or dominant form of digital identification: the very communication technology and process hundreds of millions of mobile consumers have leapfrogged entirely.

The aforementioned has revealed a clear and growing gap in accessibility for people who do not have access to an email but do have access to a smartphone and other digital and biometric identification tools and modalities. This has created, and heightened, the need for an electronic document signature and consent platform that allows users to use their smartphones and biometrics, such as their faces, voices, and eyes to sign electronic documents and provide digital consent, all the while ensuring that they do not need to have an email address to engage with digital documentation and consent processes. In developing nations, where internet access can often be unstable, or cut off at a moment's notice, it is critical that there exist digital databases dependent on mobile phone numbers, alongside other digital identifiers and biometrics, as opposed to consistent access to Wi-Fi and/or an email account. Furthermore, in technologically advanced parts of the world, hundreds of millions of people remain on the fringes of digital consent processes because they do not use or want to use email as their primary method of digital identification and verification. Thus, creating a platform that caters to these diverse populations and user groups is essential and timely.

Importantly, by breaking the digital deadlock that email and western-centric e-signature processes have long placed on the global e-signing market, hundreds of millions of people will be able to claim, and use, their very own digital identities to complete and store paperwork and consent of all kinds. Additionally, in a ground-breaking feat, many will do so for the very first time. This presents an urgent need for democratization of the e-signature, electronic document, and digital consent industries and the processes they monopolize to the disadvantage of populations globally.

### SUMMARY OF THE INVENTION

The present invention pertains to a system and method for secure electronic document exchange and execution of digital documents and digital consent contracts via a secure electronic platform with biometric access verification. The present invention allows users to generate a tokenized digital identity through a mobile phone number, which is then verified through a Short Message Service (SMS) one-time password (OTP), and biometrics such as facial or voice recognition. Any document signed, or consent process completed by the individual will then be stored within the application server, in an encrypted and secure repository of the present invention, allowing for easy and safe access to any document or digital materials that have been signed or consented for. Current e-signature platforms are much more limited than what is offered through the application of the present invention.

The electronic database consists of an environment wherein individuals may be able to collaborate throughout the contract execution or consent gathering process and provide various push notifications for when documents have been viewed, signed, and edited throughout a company, organization, or between individuals. Specific permissions are enabled, for example—the administrator of a document folder may bar access to other members of an organization, only allow specific individuals to view a document or consent materials to be executed, or transfer a document or other digital consent asset to the blockchain, by way of a specific cryptographic token or ID.

Biometric access verification is executed by way of both biometrics and cryptographic processing. The requisite for this process is a device wherein biometrics and cryptographic keys may be received and configured, such as a phone with a working camera, tablet, or a laptop. Devices with biometric sensors, such as state of the art laptops that require fingerprints, or cellular devices with fingerprint recognition, may be utilized where applicable. Another approach to biometric verification may be an iris or retina scan, which would require access to a device with a camera, and a clear scan of an individual's face, and in particular, the human eye. These methods may be employed to verify identity, particularly in instances where an SMS code may not be applicable, or for digital contract execution and consent procurement.

In accordance with the preferred embodiment of the present invention, an organization (or individual) creates an account using the application interface and sets up document spaces (“Doc Space”) via the web portal. They may add folders, collaborators, digital paperwork, and other consent assets accordingly. A Doc Space manager adds other managers to the platform who in turn download the mobile app via the Apple App or Google Play stores, set their profiles remotely, access the Doc Space, digital documents and consent assets and execute them as needed on mobile devices, on-the-go. With completed digital paperwork and consent materials of any and all kinds uploaded and stored on the platform's secure server, signees can view, share and download everything they have ever signed via the platform of the present invention, whenever they need it. It is as simple as accessing the document view web portal interface of the present invention, entering the registered mobile phone number, and responding to the SMS OTP request. The SMS OTP consists of sequential numbers or characters and may provide a secure, audible alternative for those who have vision loss.

To receive the SMS OTP an electronic device is necessary. The electronic device may contain a wireless communication system with a processor. The processer features memory blocks and collaborates with an operating system to utilize data and execute essential coding functions to generate the OTP.

In another embodiment, the present invention can be downloaded as an application on a mobile device, such as a smartphone or a tablet. Through the mobile application, users can access a secure vehicle to sign and share paperwork and consent assets and store them in their own private repositories. A growing population of mobile device owners will now have access to a secure, private, real-time, and evolving repository that can store their assorted personal paperwork and digital consent assets in one place. The platform of the present invention has been designed to serve those individuals who may require document signature, consent, execution, and management capabilities but do not have access to certain methods of communication, such as email accounts, which are currently required by conventional eSignature services and/or have leapfrogged email technology altogether to use data enabled mobile phones, coupled with other personal security and identification tools and technologies. The present invention caters widely to users who also largely rely on instant messaging platforms for the vast majority of their communication needs—be it business or otherwise.

In another embodiment, the platform of the present invention incorporates key identity verification elements such as SMS OTPs, facial recognition, on-screen signatures, video consent, voice recognition, and biometric identification. Additional elements related to personal identification and sensitive data include the implementation of decentralized blockchain technology, cryptocurrency, decentralized identifiers (DIDs), and Artificial Intelligence (AI).

The present invention may integrate mobile wallet or cryptocurrency wallet capabilities. Cryptocurrency wallets are physical mediums, programs or services that store public and private data and keys for transactions. Cryptocurrency wallets may be used in the application of the present invention to enhance security and provide the functionality of encryption for signing documents and providing wide-ranging digital consent. Cryptocurrency wallets also aid in securing transactions, as well as storing and retrieving digital assets.

The present invention may incorporate AI in the application. AI is intelligence demonstrated through machine learning, in contrast to human and animal intellect. AI may be used in the application of the present invention to maximize the potential usage of the present invention. In one embodiment, AI can be used to produce advance web search engines, or to further automate a process for convenience on both client and system ends. AI can be used to articulate and receive human speech and output a response. Identification may also occur by way of AI to determine whether a mobile user is authorized to view, sign, and execute digital documents and consent. A mobile retina scan, facial ID, or location data may be used for the assessment.

The present invention can be best described as a “d-signature” platform. Where “e-signature” platforms are based on email services, the present invention's d-signature system gives users the choice and agency to complete documentation in several safe, secure, and accessible digital ways through methods such as on-screen signing and video consent. Through the use of the present invention's digital tools (“d-tools”), the platform can grow and evolve to cater to the needs and requirements in a future of Web3 and decentralized identifiers (DIDs), globally. The present invention offers all users the chance to record, access and maintain all digital documents anytime, anywhere, regardless of whether they have an email address, a cloud subscription service, or curated virtual documentation folders.

The present invention's platform can be accessed online or through an application on a mobile smartphone or tablet device. The user can download the application and register to use it with a valid mobile phone number. Or, if users are provided access to the application by a company or organization, the user may create an account and download the application from a system-generated URL delivered via email or an instant messaging application such as WhatsApp. To access the application, the user can login by authentication through the user's mobile device password. As a security feature, the application auto-locks when not in use by the legitimate and authorized user of the device. The application can record video and audio as “virtual digital signatures” beyond the use of an on-screen virtual signing pad activated by human fingertip.

The user is able to choose documents (uploaded to the app in PDF format and in time, JPEG, Word and others) from pre-set templates and have them signed and filed repeatedly, indefinitely. These digital “docs” are templatized for use over and over again. The user can also file each completed document to a secure server/platform (at present, Amazon S3). The application has feature(s) that digitally legitimize and verify each static document. For example, an OTP sent to the signatory's nominated mobile phone number (via SMS or instant messaging application such as WhatsApp) or email address and then “affixed” or added to the given document's metadata before completion and digital locking of a said document.

The application can digitally lock completed static documents so that in no way can they be reopened, tampered with, or altered once all pre-filled sections are completed. The digital lock function must also automatically send (via a URL) a downloadable copy of the completed document to the signatory's nominated mobile phone number (via SMS or instant message) or email address (where present/required). The application can also function offline, allowing users to access and complete forms without internet connectivity and file completed forms to their server of choice when online and connected to the internet. The application allows signees to access completed documents indefinitely and infinitely via the present invention's web-based document viewer (“Doc Viewer”), accessed by users with their registered mobile phone number and uniquely generated OTP.

The present invention can be used in just about any situation where virtual documents must be stored for signing and filing, and where such processes as consent must be repeated in fluid and ad hoc scenarios. The present invention can be used in multiple environments, document, and consent situations where intent and planning have not or cannot underpin an active, positive, safe and accessible outcome for all parties.

The disclosed e-signature platform is particularly useful in the business sector. With the rapid growth of remote jobs and opportunities, there is also an increased demand for digital consent and contracting. Since previous adaptions of digital contracting require external accounts such as emails, requiring verification by way of an OTP through a mobile device makes the approach significantly more accessible to relevant parties anywhere, and particularly for those who may wish for more discretion and seek greater real-time virtual online safety and verification. The use of OTPs also aligns with the mass adoption of mobile phones and the resulting proliferation of shared universal mobile technology knowledge and language.

The present invention can be applied to and support a multitude of markets, segments, and industries, such as: healthcare, finance, real estate, government, telecoms, and official agencies, media, entertainment, and advertising, to name a few. The present invention can be used anywhere or in any scenario where documents such as registration/consent/usage/licensing processes need to be completed repeatedly on-the-go in creative, fast moving, and unpredictable environments. For field research and documentation applicability, the present invention can be used to conduct everything from market surveys and field documentation, to government census processes and election polling. For international agencies, the present invention can provide mobile solutions to process large numbers of people in need of assistance in compressed time frames in fluid environments, as well as nongovernmental organizations (NGOs) embedded with communities on sustained or longer-term projects and initiatives. Government and official agencies can use the present invention to assist in facilitating medical attention and sustained healthcare, and it can positively serve law enforcement and utilities companies. Real estate, banking and financial transactions are also made more immediate and secure in mobile-first environments by the present invention. The present invention incorporates customer service, support, and documentation for users. To assist in the use of the platform, the present invention's customer support team can be available via phone, online and mobile instant messaging services. Traditional customer support can be paired with a network of in-market representatives who will, globally, raise in-person, in-community and industry-targeted awareness of the platform and application and how to use it.

In some embodiments, documents and signatures may manifest on a digital ledger, which is a decentralized or distributed database or repository consisting of all pertinent documents, as uploaded by the user. In this example, each document is considered a cryptographically secure asset, with a history of all interactions recorded on a blockchain ledger. Smart contracts, which are self-executing contracts that list terms, agreements, and policies. In agreements which involve buying and selling, this “d-signature” platform enables smart contracts that write agreements directly within lines of code on the blockchain network. This process, once deployed on the blockchain, allows each interaction and transaction to be traced with transparency and in perpetuity.

Regardless of whether a contract is tied to a decentralized network or ledger, users may be able to view if their document has been altered in any way, shape, or form. That is, the system may use AI to track any and all active changes and provide a history of these changes, as well as precise metadata on when contracts were signed, or digital consent collected.

A suite of services in relation to this d-signature platform, as incorporated in the present invention, may also be offered. In addition to the standard and/or conventional e-signature service offerings, the present invention presents and provides additional elements such as a contract management platform, instant smart contract execution, agreement generators, and consent automation, as well as identification verification logins.

This present invention allows all affiliated users to view the document and assign fields to specific users. For end users, only certain fields may be editable, if they are given the appropriate permissions. This feature can be used to ensure that users do not create any illustrations or sign anywhere they are not authorized to sign. The form or document generator will also offer audio-captions, if enabled, for those who may have vision loss.

The platform may track and showcase all changes and notify users on all fronts when a document has been assessed and executed. For project-oriented document retrieval, the management system will allow the creation of folders and collaboration spaces for individuals to access and work on documents and consent materials. Another feature of the present invention is the ability to annotate documents for personal use, giving users the tools and processes to highlight, strike, bold and interpret specific parts of their document without sending the annotations to the document owner. Moreover, these annotations can also be cross-collaborative, that is, a document owner can turn on settings to allow other users (who have verified access to the document) to engage with specific parts of a document—an aspect particularly beneficial for translators in low-literacy communities, globally.

Agreement generators may utilize AI to gather terminology, phrases and words used in similar contractual or consent flows and provide templates for the execution of digital documents, agreements, and other consent materials. Additionally, the platform may be used as an identification verification database for users in developing nations or in populations in technologically developed regions where email is no longer the dominant or preferred form of digital identification.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is diagram of the application server flow of the present invention.

FIG. 2 is a diagram of the application flow of the present invention.

FIG. 3 is a flow diagram of the super admin interface of the present invention.

FIG. 4 is a flow diagram of the project admin interface of the present invention.

FIG. 5 is a flow diagram displaying the customer admin interface of the present invention.

FIG. 6 is a diagram of the signature and form viewer of the present invention.

FIG. 7 is a flow diagram of the form interface of the present invention.

FIG. 8 is a diagram of the single subject mobile application flow of the present invention.

FIG. 9 is a diagram of the facial recognition verification flow of the present invention.

FIG. 10 is a diagram of the single face identification flow of the present invention.

FIG. 11 is a diagram of the multiple face identification flow of the present invention.

FIG. 12 is a diagram of the multiple subject flow of the present invention.

FIG. 13 is a diagram of the mobile forms flow of the present invention.

FIG. 14 is a diagram of the multiple signature flow of the present invention.

FIG. 15 is a diagram of the notifications flow of the present invention.

FIG. 16 is a diagram of legal guardian signature flow of the present invention.

FIG. 17 is a line diagram illustrating a decentralized network.

FIG. 18 is a line diagram illustrating a distributed network.

### DETAILED DESCRIPTION OF THE PREFERRED EMBODIMENT

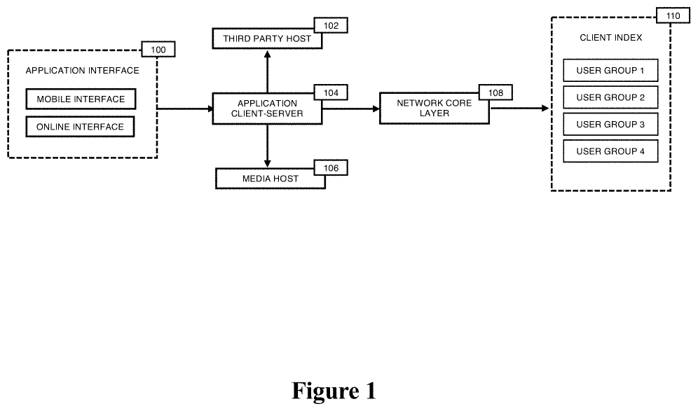

FIG. 1 is diagram of the application server 100 flow of the present invention. In accordance with the preferred embodiment of the present invention, the application interface 100 may be accessed through a mobile device or online. The application interface communicates with an application client-server 104. Both the mobile and online interface 100 go into the application client-server. The application client-server goes to both the third-party host 102 and the media host. The application client-server then goes towards network core layer 108. This in the end goes to the client index 110, which holds all the user groups.

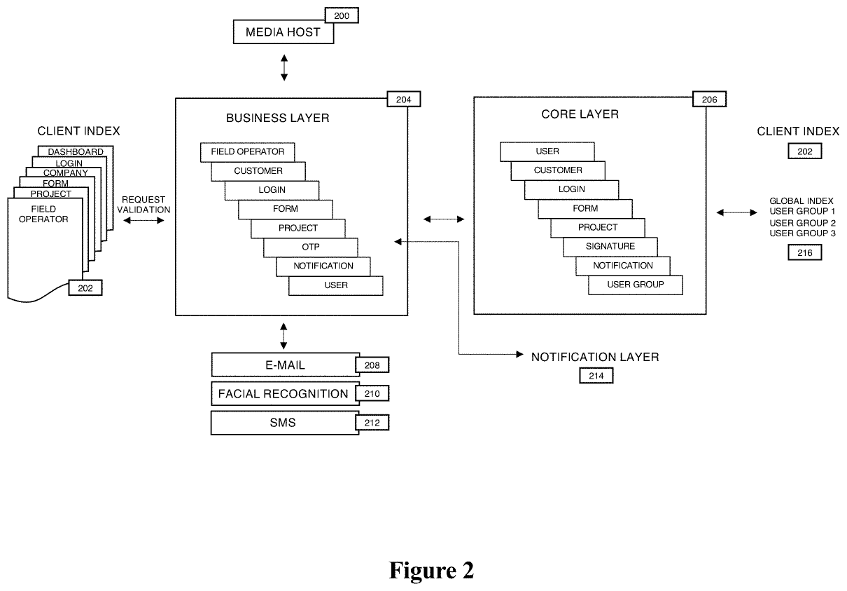

FIG. 2 is a diagram of the application flow of the present invention. In accordance with the preferred embodiment of the present invention, the client index interface 202, which may include a dashboard, login, company, form, project, and field operator. With the request of the application, this leads into the business layer 204. Within the business layer 204, there is access to the field operator, customer, login, form, project, OTP, notification, and user. This business layer is accessed by the media host 200 and leads to email 208, facial recognition 210, and SMS verification options 212. The business layer 204 also leads into the notification layer 214, where the user will be notified by the app about any documents. From the business layer 204, it goes into the core layer 206, which also has access to the user, customer, login, form, project, signature, notification, and user group. This then goes into the client index 202, which has access to a global index along with all the user groups 216.

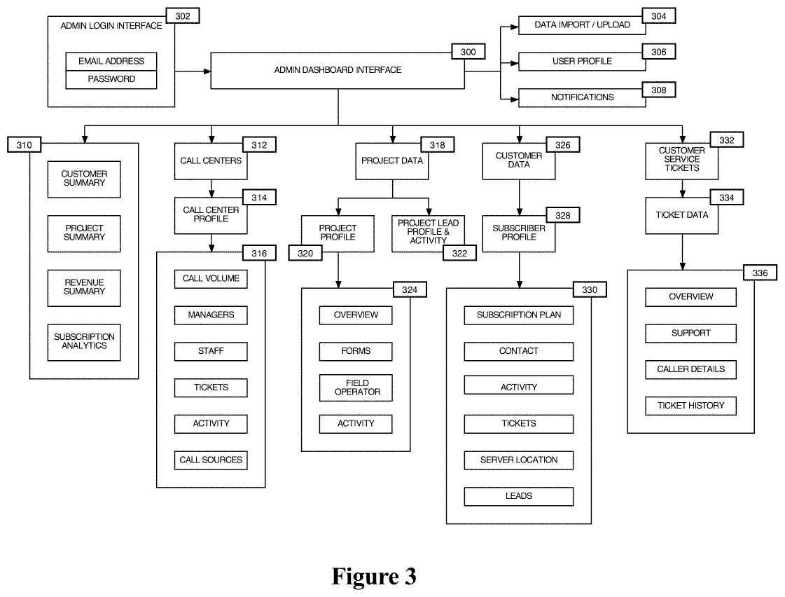

FIG. 3 is a flow diagram of the super admin interface of the present invention. In accordance with the preferred embodiment, the admin user can access the admin dashboard interface 300 by first signing into the application through the login interface 302 using their admin account email and password. Once the email address and password are successfully verified, the admin dashboard interface 300 allows the user to view multiple data profiles and execute functions such as data importing and uploading 304, view and edit the user's profile 306, and view notifications 308. Within the admin dashboard 300, the user may view relevant data groups such as the customer summary, project summary, revenue summary and subscription analytics 310. Additionally, there might be summaries of call center 312 data, such as the call center profile 314 which showcase all pertinent profile data 316 such as the call volumes, manages, staff, tickets, activity, and call sources. The dashboard also showcases project data 318 as well as a project profile 320 and project lead profile and activity 322. The project profile 324 will consist of an overview, forms, the field operator, and activity channels 324. Customer data 326 is also securely stored, with a subscriber profile 328 and a set of subscriber channels 330 such as the subscription plan, contact information, activity, tickets, server locations and leads. Finally, there is a customer service ticket 332 module, which relays ticket data 334, as well as an overview channel 336 that features support, caller details, and ticket history data.

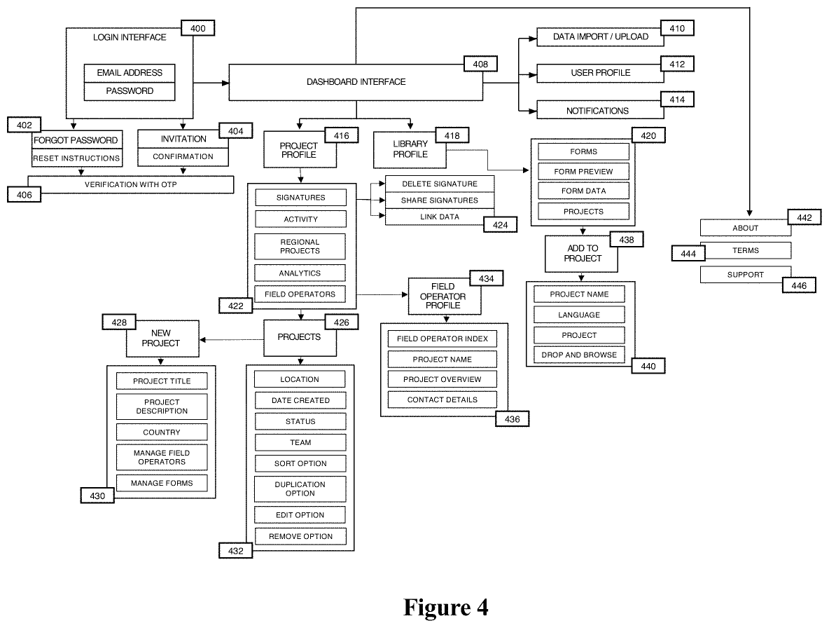

FIG. 4 is a flow diagram of the project admin interface of the present invention. In accordance with the preferred embodiment, the project admin user gains access by logging in through the administrative login interface 400, using their email address and password. If a project admin cannot access their account, or they forgot their password 402, they have two modes to retrieve that information. The user may be presented with reset instructions 402 and a one-time passcode (OTP) 406 to verify their identity. Alternatively, admins are also given the option to login via invitation 404 and provide confirmation. The figure also displays other elements, such as project profiles 416, wherein the admin can view project profile modules 416 signatures, activity, projects by region, analytics, and their respective field operators. In the project profile module 416, users may view projects 426, with project data and controls 432.

They also, from the project module 426, have the option to create a new project 428. This redirects them to a new project tab 430 which allows a user to input project titles, descriptions, the country the project is operating in, as well as management for field directors and forms. Field operators are also given a field operator profile 434 which displays field operating modules 436 with an index, project names, overview, and contact details. Admins are also allowed a view of library profiles 418, wherein form data is presented. A library module 420 features forms, form previews, form data and projects—as well as the option to add and delegate files and pages to projects 438 and customization tabs 440. The library profile 418 also gives individuals access to forms, form previews, form data, and projects 420, as well as the option to add to projects 438. When users add forms to projects 438, they must input project data 440 such as the name of the project, the language it should be written in, the project itself, and drop and browse options. The dashboard interface 408 also features an about page 442, terms page 444 and support page 446.

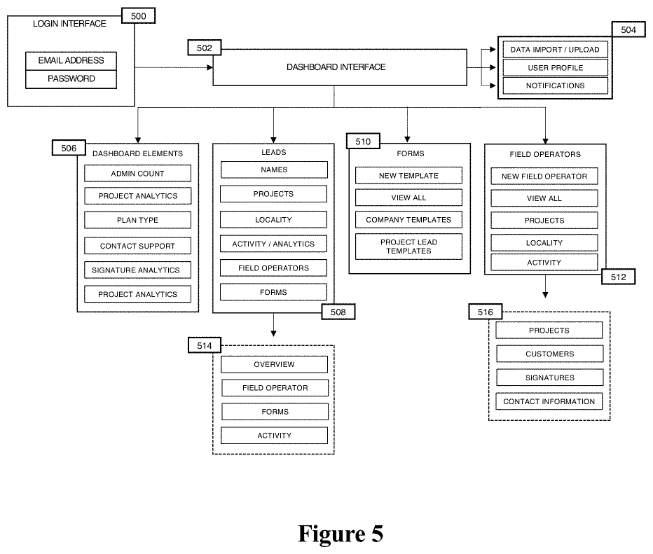

FIG. 5 is a flow diagram displaying the customer admin interface 502 of the present invention. A customer admin can enter their account with the simple login interface 500, and upon doing so, they may upload and import data 504, view their user profile and keep up with notifications. The customer admin is also given access to dashboard elements 506, such as admin count, plan types, support, and project and signature analytics. In the preferred embodiment, the admin is also provided with access to leads 508, forms 510 and field operators 512. The leads page 508 provides an overview 514 of the project, forms, and an activity section. The field operator page 516 features a subcategory for projects, customers, signatures and contact information.

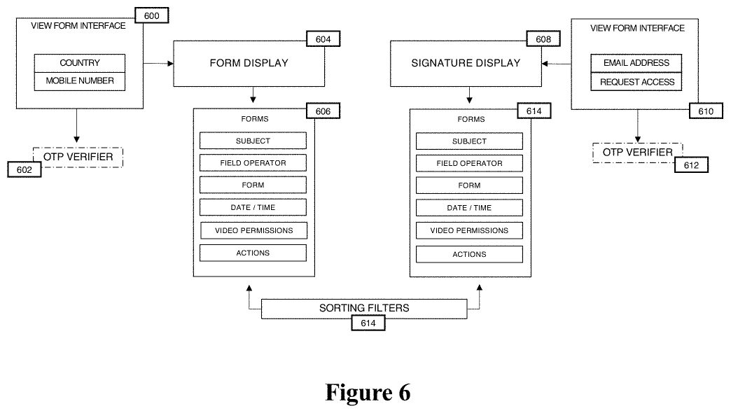

FIG. 6 of the present invention is a signature and form viewer, wherein clients can view forms 600 by providing regional information and their mobile numbers 600, which then generates a one-time passcode 602 for verification purposes. In the preferred embodiment, a client can view the signature 608 and form 604 display. The signature display 608 has a view form interface 610 which consists of an email address for those who can request access by way of an OTP verifier 612. The form displays 604 and signature displays 608 provide a view of each form 606, which contain various fields for the subject, field operator, date and time, video permissions, actions, and the form itself. Each of these aspects have sorting filters 614 for ease of access.

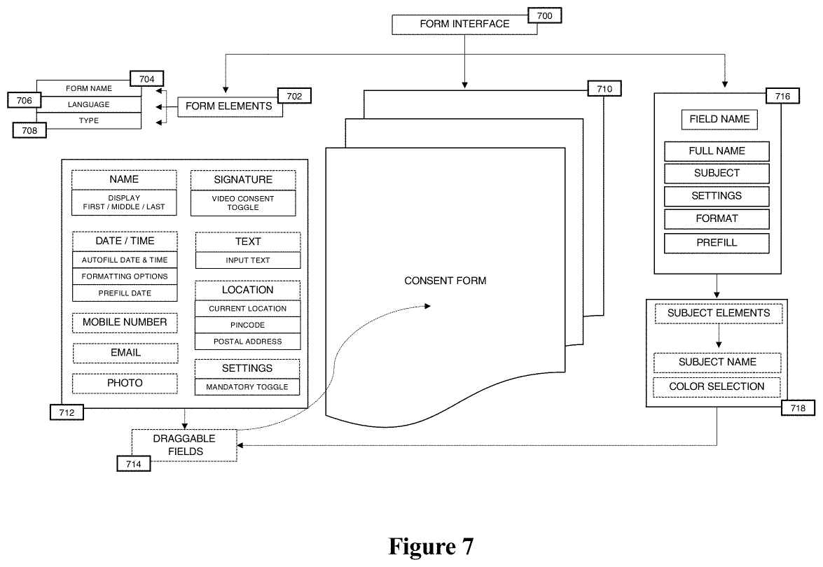

FIG. 7 is a flow diagram that addresses the form interface 700 of the present invention, with drag and drop options 712 for signatures, text, location, subject elements, and names. The drag function allows a client to customize their document with relevant information, as well as how to display that information. Form elements 702 consist of the form name 704, form language 706 and the form type 708. The draggable fields 714 are marked by the dashed lines and may be dragged on to the consent form 710. Each dragged object consists of a field name 716 and other fields, such as the signee's full name, the subject of the document, settings, format and prefill options. Moreover, there are subject elements 718, such as the subject's name, and the desired color selection that may be dragged, dropped, and customized.

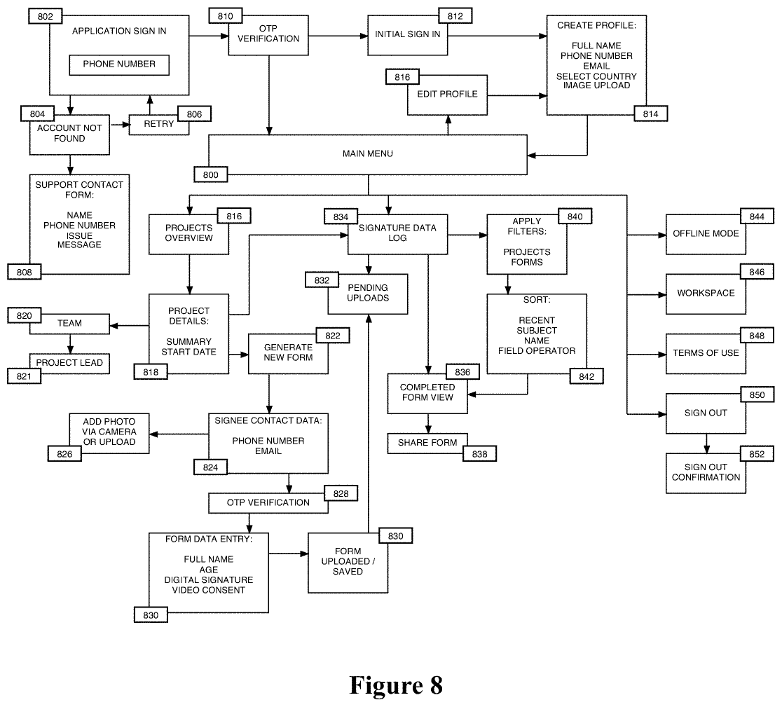

FIG. 8 is a diagram of the single subject mobile application flow of the present invention. The user can sign into their account through the sign interface 802 by entering their mobile phone number for an OTP verification code 810. If the number is not recognized in the system 804, the user is able to contact support 808 or retry 806. Once the user successfully logs in 812, the second layer of authentication is then initiated through the entry of an OTP sent to the user's mobile device via SMS 810. Once the OTP has been successfully verified, the user is able to create a user profile 814 upon initial sign into the application. The user can then also access the main menu 800. The user can access project data associated with the user's account, including the details for each project 818, such as the project summary 818. The user may then generate a new form 822, provide signee contact data 824, which prompts the OTP verification 828. The form is then available for data entry 830 and can be uploaded and saved. It may also pend upload 832. The projects overview also shows start date, as well as the user profiles of other people on the project team, including the team lead 820 and project lead 821. Signature data 834 can be logged in project details 818. The signature data log 834 has filters 840, which allow users to sort through form fields and data 842 and view 836 and share 838 complete forms. The project overview 816 also had an offline mode 844, a workspace 848, terms of use page 848, a sign out option 850 and a sign out confirmation page.

For each project, the user can generate a new form and enter the intended signee's contact data such as a mobile phone number or email address. The user can also upload a photo of the signee associated with the form and signature. The signee can access the form on their mobile device for signature collection 830 and entry of identifying data such as the subject's name once the signee has been successfully authenticated through the entry of an OTP 828 sent to the signee's mobile device via SMS. The signee can then execute the form through a verbal signature via video 826, using the camera of the mobile smartphone device, or a digital signature directly through the application signature interface 830. The signed form is then saved to the user's account profile. The user can access all pending uploads and saved signed forms through the project data interface.

In summation, the user can access the signature data interface through the application's main menu 800. The signature data log interface acts as the repository for completed, signed forms. The user can also share signed forms with others 838. The user can search the signature database by applying filters such as projects or forms 840. The user can sort the results by recent uploads, the subject, the name, or the field operator associated with that form signature 842. The user is also able to access additional options through the main menu of the mobile application. One option is to switch the application to offline mode 844, wherein the user may use the app without internet connectivity. Another option is the selection of specific workplaces 846 associated with the user's account. The user can also view the terms of use of the mobile application 848. If the user is finished with the application and wants to securely sign out 850, the user is able to do so by confirming through the sign out interface 852.

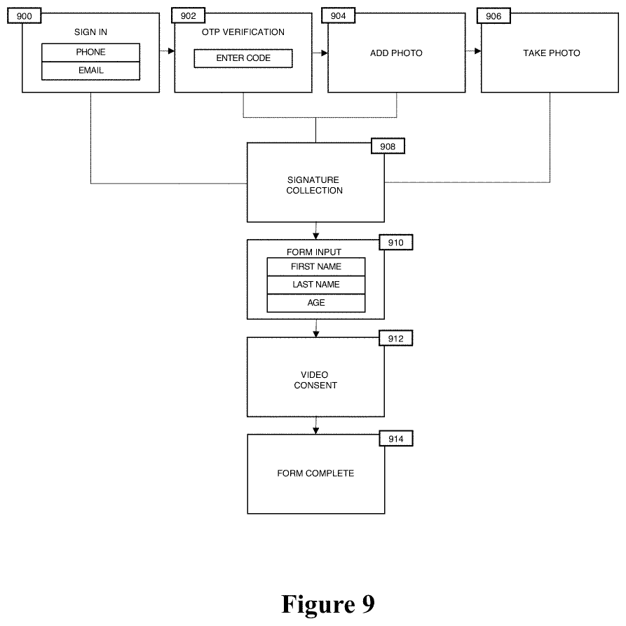

FIG. 9 is a diagram of the facial recognition verification flow of the present invention's signature collection 908. User verification through facial recognition 904 may be presented as an option to a user when logging in 900 to the application on a mobile device. The user signs into their account through the login interface 900 by entering the mobile phone number and password 900 associated with their account. The second layer of authentication is then initiated through the entry of an OTP 902 sent to the user's mobile device via SMS. Once the OTP 902 has been successfully verified, the user is presented with the option to upload a photo 904 stored in the mobile device or take a photo with the camera 906 of the mobile device, for the purposes of facial recognition verification. The user then proceeds to the signature collection interface 908, wherein a form is generated with the user's basic identifying information 910, including the user's name and age 910. By uploading a photo 904 of the user to be tied with the user's account profile, the user can then provide a verbal signature via video 912, using the camera of the mobile smartphone device. Once the user has completed the execution of the form through verbal video signature, the form process is complete 914.

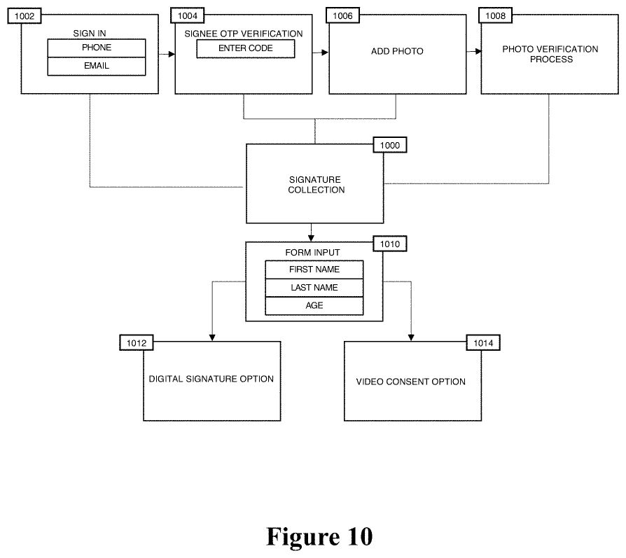

FIG. 10 is a diagram of the single face identification flow of the present invention. For single user verification through facial recognition, the user signs into 1002 their account through the login interface 1002 by entering the mobile phone number and password 1002 associated with their account. The second layer of authentication is then initiated through the entry of an OTP 1004 sent to the user's mobile device via SMS. Once the OTP 1004 has been successfully verified, the user is presented with the option to upload a photo 1006 stored in the mobile device or take a photo 1008 with the camera of the mobile device, for the purposes of facial recognition verification. Once the photo of the user's face is uploaded to the application 1006, the image is verified 1008 using an AI based algorithm. The user then proceeds to the signature collection interface, wherein a form is generated with the user's basic identifying information 1010, including the user's name and age 1010. The successful verification of the user's identification photo, the user can then provide a verbal signature and consent via video 1014, using the camera of the mobile smartphone device, or a digital signature 1012 directly through the application signature interface. Once the user has completed the execution of the form through verbal video signature consent 1014 or digital signature 1012, the form process is complete, and the signature has been collected 1000.

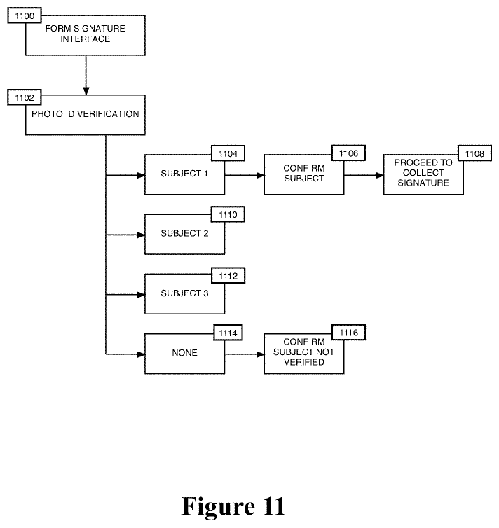

FIG. 11 is a diagram of the multiple face identification flow of the present invention. Within the form signature interface 1100, the user may verify the uploaded photo identification 1102 of multiple subjects, in this example, subject (1) 1104, subject (2) 1110, subject (3) 1112, or none—no recognized subject 1114. Once the user selects the subject, in this case, subject (1) 1104 the user confirms that the photo matches the subject 1106 and may proceed to collect the subject's signature 1108. If the user does not recognize any of the subject photo options 114, the user can confirm that the subject has not been verified 1116 by the user through photo identification.

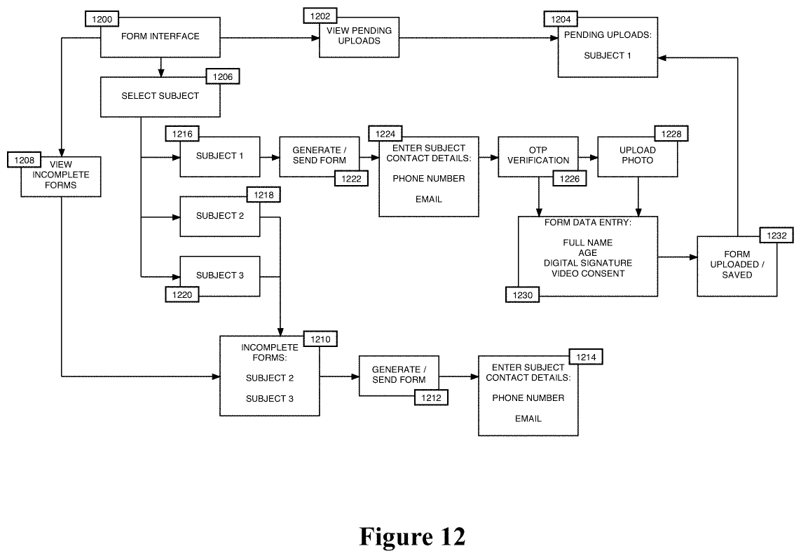

FIG. 12 is a diagram of the multiple subject flow of the present invention. The present invention can facilitate multiple signatures for a form. Within the form interface 1200 of the mobile application, the user can select 1206 from a list of designated subjects, in this example, subject (1) 1216, subject (2) 1218 and subject (3) 1220. Once the subject is selected, the user can generate and send the form 1222 to the subject by entering the subjects contact details 1224 such as their mobile phone number or email, which will then prompt an OTP verification code 1226. The subject 1216 can access the form on their mobile device for signature collection and entry of identifying data such as the subject's name. The subject can also upload a photo 1228 for facial recognition verification to be associated with the form and signature 1230. The subject can then execute the form through a verbal signature via video, using the camera of the mobile smartphone device 1230, or a digital signature directly through the application signature interface 1232. The signed form is then saved 1232 to the user's account profile as a pending upload and the user can repeat this process for multiple designated subjects. The user is also able to view the pending uploads 1202 related to the form as well as forms that are incomplete and which subjects still require a signature 1204. Through the incomplete forms view, the user can select the subjects from the incomplete list 1210 and generate and send forms 1212 through the entry of each subject's contact information 1214, such as their mobile phone number or email 1214.

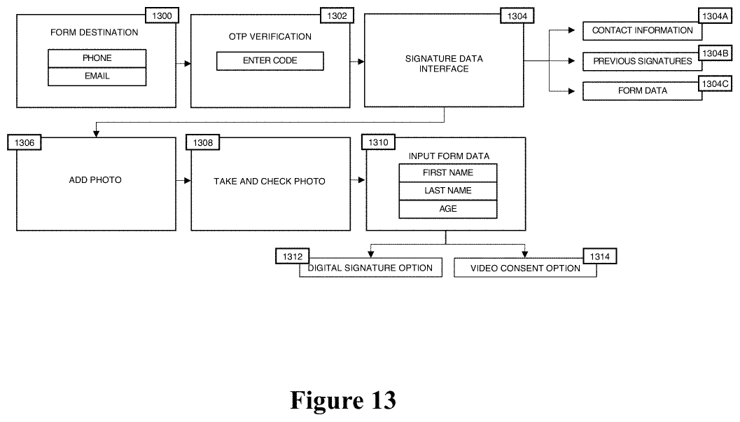

FIG. 13 is a diagram of the mobile forms flow of the present invention. The user is able to access multiple forms through the mobile application of the present invention when forms are sent 1300 to the user's mobile phone number or email address. The user enters their mobile phone number and password to access the forms associated with the user's account. The second layer of authentication is then initiated through the entry of an OTP 1302 sent to the user's mobile device via SMS. Once the OTP 1302 has been successfully verified, the user can access the signature data interface 1304. The user can view contact information 1304A, previous signatures 1304B and form data 1304C. Through the signature data interface 1304, the user can also upload a photo 1306 and check the photo to verify the signee 1308. The user can generate a form 1310 and input identifying data such as the signee's full name and age 1310. The signee can then execute the form through a verbal signature via video 1314, using the camera of the mobile smartphone device, or a digital signature directly through the application signature interface 1312.

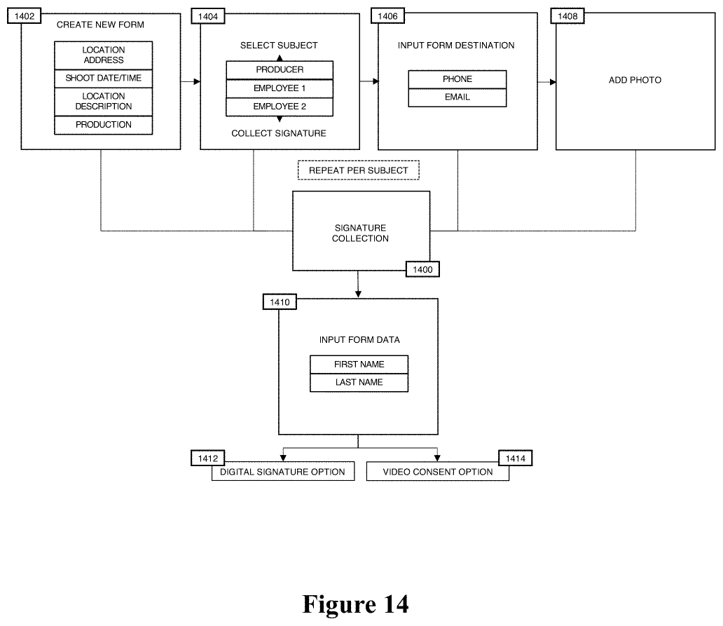

FIG. 14 is a diagram of the multiple signature flow of the present invention. Using the mobile application, the user can generate a new form 1402 and enter relevant data, for example, location address, time, location description and production. The user can then select a subject 1404 from multiple subjects to collect a form signature from each subject. Once the subject has been selected, the user can send the form 1406 to the subject using the subject's mobile phone number or email. The user can also upload a photo 1408 of the subject to be associated with the form and signature. The subject can access the form on their mobile device for signature collection and entry of identifying data such as the subject's name 1410. The subject can then execute the form through a verbal signature via video 1414, using the camera of the mobile smartphone device, or a digital signature directly through the application signature interface 1412. Upon completion, the signature is collected 1400. The signed form is then saved to the user's account profile and the user can repeat this process for multiple subjects.

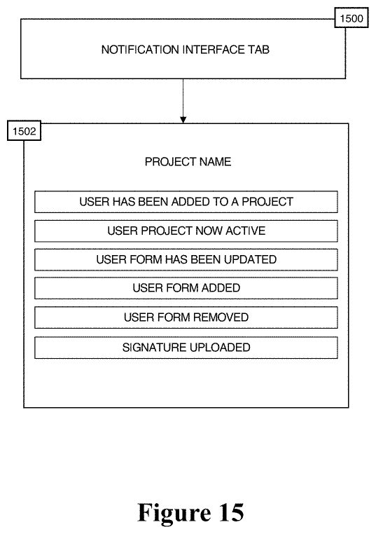

FIG. 15 is a diagram of the notifications flow of the present invention. Through the notifications interface associated 1500 with the user's account, the user can view all notifications associated with each project. Examples of notifications can include if another user has been added to a project 1502, project status, updates to the form, if a form has been removed, and if a signature has been uploaded.

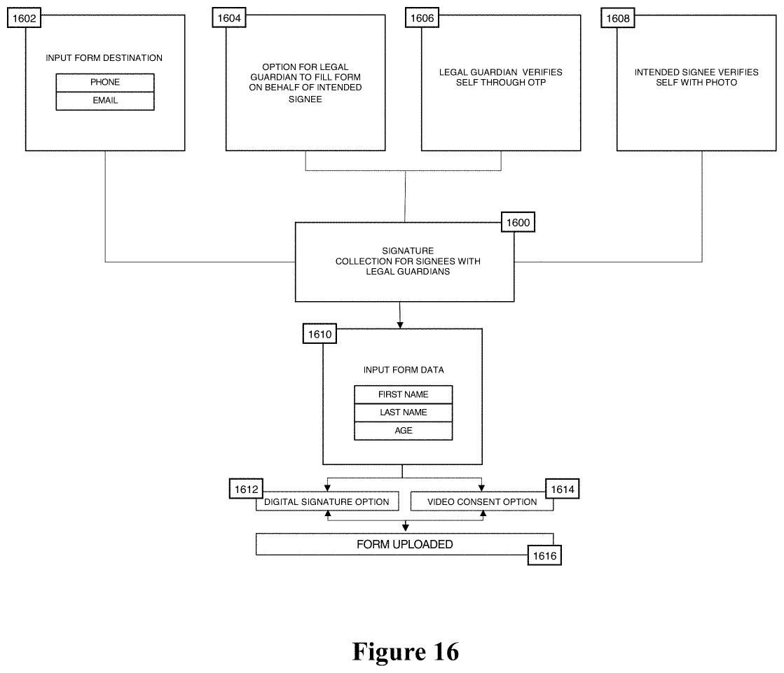

FIG. 16 is a diagram of legal guardian signature flow of the present invention. Once a form is transmitted through the application to a subject's mobile phone number or email address, the subject or the subject's legal guardian can access the form, wherein the legal guardian can fill out the form on behalf of the subject. The legal guardian can access the signature collection data interface through the entry and authentication of an OTP sent to the subject or guardian's mobile device via SMS. Once the OTP has been successfully verified, subject or intended signee can upload a photo for facial recognition verification to be associated with the form signature. The subject or guardian enters identifying data for the subject, such as full name and age. The subject or guardian can then execute the form through a verbal signature via video, using the camera of the mobile smartphone device, or a digital signature directly through the application signature interface. the signed form is then uploaded and stored on the application server.

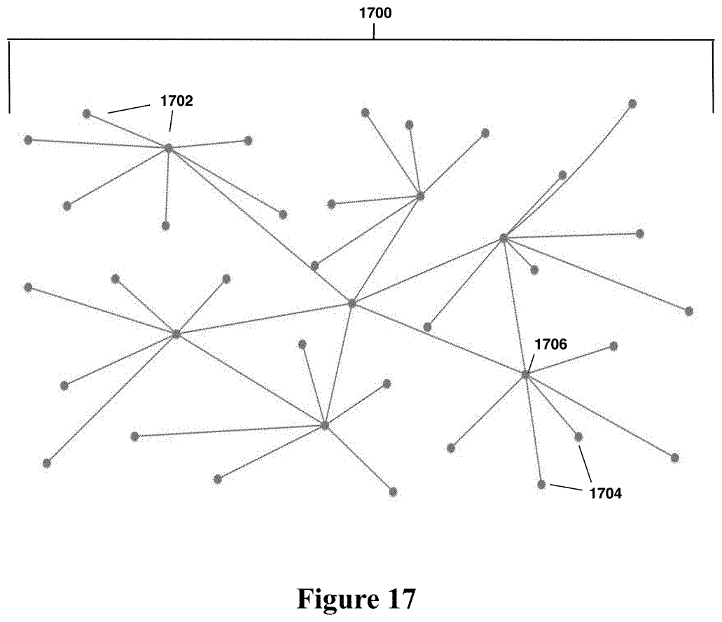

FIG. 17 is a line diagram illustrating a decentralized network. In accordance with the preferred embodiment of the present invention, the specific architecture of the network can be either decentralized or distributed. FIG. 17, generally represented by the numeral 1700, provides an illustrative diagram of the decentralized network. FIG. 17 depicts each node with a dot 1702 Under this system, each node is connected to at least one other node 1704. Only some nodes are connected to more than one node 1706.

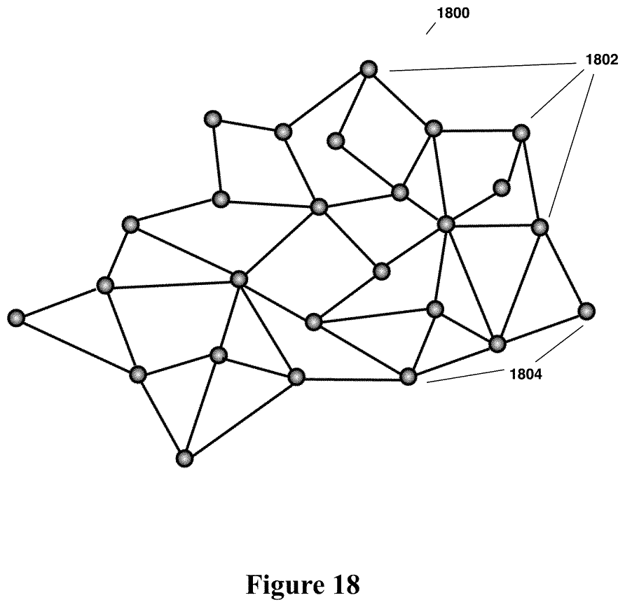

FIG. 18 is a line diagram illustrating a distributed network. For comparison purposes, FIG. 18, which is generally represented by the numeral 1800, illustrates a distributed network. Specifically, the illustration shows the interconnection of each node 1802 in a distributed decentralized network 1800. In accordance with the preferred embodiment of the present invention, each node 1802 in the distributed network 1800 is directly connected to at least two other nodes 1804. This allows each node 1802 to transact with at least one other node 1802 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provides services comprising receiving client update information from client devices and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for secure electronic document exchange and execution of contracts and consent via a secure electronic platform with biometric access verification, comprising:
a secure electronic platform, wherein a digital identity is generated through a mobile phone and verified through a short message service one-time password by way of a wireless communication device and processor;
wherein a mobile phone has associated with it a mobile phone number;
wherein said processor utilizes an array of memory blocks to collaborate with an operating system to generate a plurality of one-time passwords;
a consent process, wherein personal paperwork and digital consent assets executed in the electronic platform are stored within an encrypted, secure repository;
an application interface that communicates with an application client-server to establish a digital identity for document exchange and contract execution; and
wherein establishing the digital identity comprises utilizing biometrics, including facial, voice and iris recognition, digital identifiers, decentralized identifiers and its associated mobile phone and mobile numbers.

2. The system according to claim 1, wherein said encrypted and secure repository operates within an application server and feature specific permissions.

3. The system according to claim 2, further comprising said secure repository in a decentralized, distributed database and network.

4. The system according to claim 1, wherein said consent process comprises of utilizing said biometrics to execute contracts and confirm said digital identity.

5. The system according to claim 1, wherein said one-time password is sent to a mobile phone supporting said processor utilizing wireless communication to generate said plurality of sequential numbers for secure access to said application.

6. The system according to claim 1, wherein said digital consent process includes verbal signage, by way of a video, streamed on said mobile device or smartphone with a camera in said application interface.

7. The system according to claim 3, further comprising said decentralized or distributed network and a plurality of registry servers that receive client update information regarding said digital identities and assets.

8. A system secure electronic document exchange and execution of contracts via a secure electronic and blockchain platform with biometric access verification, comprising:
a blockchain-enabled platform, wherein digital consent assets and personal paperwork are cryptographically secure assets;
wherein said cryptographically secure assets are units on a digital ledger, configured to execute:
smart contracts, capable of self-executing agreements with specific terms, limitations, agreements, and policies on digital consent paperwork and documents, programmed by lines of code on an operating system;
a contract generator, capable of generating consent by way of a processor in the application interface; and
biometric access verification and consent, wherein users verify their digital identities with facial, voice and iris recognition, decentralized identifiers, and digital identifiers by way of a mobile phone and a mobile phone number.

9. The system according to claim 8, wherein said digital ledger records and maintains a file history of all modifications and alterations to a said digital consent asset or personal document.

10. The system according to claim 8, wherein said application interface hosts a signature interface and collaboration spaces through a management system.

11. The system according to claim 8, wherein said iris recognition is executed using an electronic device with a camera.

12. The system according to claim 8, wherein said digital ledger is immutable and can show attempts at editing said digital consent paperwork and documents.

13. The system according to claim 8, wherein said smart contracts that operate on said blockchain-enabled platform also enable consent automation and pre-fill documents.

14. The system according to claim 8, wherein said blockchain-enabled platform utilizes artificial intelligence gathered by way of a mobile phone, with a camera and processor, to confirm a user's digital identity.

15. A method for secure electronic document exchange and execution of contracts via a secure electronic platform with biometric access verification, the method comprising:
securing digital identities on an electronic platform by way of biometric identifiers;
generating and verifying a digital identity through mobile phone and electronic device through a short message service or one-time password;
processing an array of memory blocks on an operating system to generate a series of one-time passwords;
utilizing biometrics, including facial, voice and iris recognition alongside digital identifiers to confirm the digital identities of users;
accessing a signatory vehicle, interface, and platform after confirming a digital identity;
signing, verbalizing, and consenting to documents and digital assets on an electronic signage platform by way of digital identifiers and biometrics;
storing personal paperwork, documents, and digital consent assets in an encrypted and secure repository;
encrypting and securing personal paperwork, documents and digital consent assets in a blockchain enabled repository;
establishing activity channels on a cryptographically secure and encrypted platform for collaborative document signing, sharing and editing; and
recording document and contract-related interactions on a cryptographically secure platform in perpetuity.

16. The method according to claim 15, wherein said cryptographically secure and encrypted platform converts a document or file into a cryptographic asset.

17. The method according to claim 15, wherein said cryptographically secure platform operates on a blockchain-based network.

18. The method according to claim 17, further comprising said blockchain-based network recording document and contract related interactions in said repository as units on an immutable digital ledger.

19. The method according to claim 15, wherein said activity channels enable the collaborative management of digital paperwork and assets.

20. The method according to claim 15, wherein said blockchain-enabled repository operates within an application server and feature specific permissions.
